(19) United States
(12) Patent Application Publication
(10) Pub. No.: US 2015/0289324 A1
(43) Pub. Date: Oct. 8, 2015

(54) MICROWAVE OVEN WITH THERMAL IMAGING TEMPERATURE DISPLAY AND CONTROL

(71) Applicant: Mark Braxton Rober, Valencia, CA (US)

(72) Inventors: Mark Braxton Rober, Valencia, CA (US); John Leichty, Pasadena, CA (US)

(21) Appl. No.: 14/680,313

(22) Filed: Apr. 7, 2015

Related U.S. Application Data
(60) Provisional application No. 61/975,983, filed on Apr. 7, 2014.

(51) Int. Cl. H05B 6/68; H05B 6/64; H05B 6/66

(52) U.S. Cl. CPC H05B 6/68; H05B 6/668; H05B 6/6455

(57) ABSTRACT

A microwave oven is shown and describe which includes infrared thermal imaging cameras. The infrared thermal imaging cameras are used to display heat maps of food items being cooked on a local LCD or on a remote mobile device, such as a smart phone. Other sensors such as microphones and hygrometers may also be used for display and for controlling cooking. Optical images may also be provided via optical cameras. The temperature values provided by the infrared thermal imaging cameras may be used for temperature control and/or to generate (and then execute cooking based upon) crowdsourced optimal cooking models tailored to specific food items and microwave ovens.

### CROSS-REFERENCE TO RELATED APPLICATIONS

This application claims the benefit of U.S. Provisional Patent Application No. 61/975,983, filed on Apr. 7, 2014, the entirety of which is hereby incorporated by reference.

### FIELD

The present disclosure relates to microwave ovens with improved cooking control and cooking visualization features.

### BACKGROUND

Microwave ovens are well-known consumer kitchen appliances used to quickly heat food. Using a microwave generator known as a magnetron, typical consumer microwave ovens bombard a food item with electromagnetic radiation in a high frequency range of about 2.45 GHz, causing polarized molecules in the food item to rotate and generate heat via friction, thereby cooking the item.

Users generally select a power level (or default to 100% power) using a control panel on the front of the microwave and then enter a desired cooking time. Many food items are cooked by a process of trial and error, with the user periodically pulling the food item out of the oven and touching it to determine if it is sufficiently cooked and re-heating it as required. The heating characteristics of a particular cooking event are dependent on the size and composition of the food item and the design of the microwave. Thus, it can be difficult to determine the correct cooking time for a given food item, even when cooking pre-packaged foods with recommended cooking times shown on the packaging. Users often need to stay in close physical proximity to the microwave while cooking food items in order to re-heat the item until cooking is completed. Even then, the user's touch is not necessarily a reliable indicator as to whether the item is cooked throughout, as significant spatial temperature gradients may be present.

Thus, a need has arisen for a microwave oven that addresses the foregoing issues.

### BRIEF DESCRIPTION OF THE DRAWINGS

The disclosure will now be described, by way of example, with reference to the accompanying drawings, in which:

FIG. 1 is front elevational view of a microwave oven with a display showing a heat map of a food item being cooked;

FIG. 2 is a front elevational view of the interior of the microwave of FIG. 1 with the door removed showing the placement of infrared thermal imaging cameras, an optical camera, a hygrometer, a weight sensor, a rotational platter position and/or speed sensor, and a microphone;

FIG. 3 is an electrical schematic of the components of the microwave oven of FIG. 1;

FIG. 4 is a functional schematic of the microwave oven of FIG. 1;

FIG. 5 is a front elevational view of a mobile device with a microwave oven cooking control interface showing a heat map of a food item being cooked and controls for operating the microwave oven;

FIG. 6 is a schematic depiction of a crowdsourced cooking system;

FIG. 7 is a flow diagram illustrating a method of cooking with a microwave in the network of FIG. 6 using crowdsourced cooking parameters; and

FIG. 8 is a flow diagram illustrating a method of generating crowdsourced cooking parameters.

### DETAILED DESCRIPTION

The present disclosure relates to smart microwave ovens with improved controls and cooking visualization techniques. In a first aspect of the present disclosure, a microwave oven is provided which comprises a housing comprising an internal heating chamber, a microwave radiation generator, at least one infrared thermal imaging camera having a field of vision in the heating chamber, wherein the at least one infrared thermal imaging camera generates a set of temperature signals, each temperature signal in the set of temperature signals having a value and corresponding to a location within the field of vision, and a controller, wherein the controller is programmed to receive the set of temperature signals and adjust a cooking parameter based on the values of the temperature signals in the received set of temperature signals.

In accordance with a second aspect of the present disclosure, a microwave oven is provided which comprises a housing comprising an internal heating chamber, a microwave radiation generator, at least one infrared thermal imaging camera having a field of vision in the heating chamber, wherein the at least one infrared thermal imaging camera generates a set of temperature signals, each temperature signal in the set of temperature signals having a value and corresponding to a location within the internal heating chamber, and a display that is operable to selectively display a heat map, wherein the heat map comprises colors corresponding to the values the temperature signals in the set of temperature signals at locations on the display corresponding to the field of vision locations to which the temperature signals correspond.

In accordance with a third aspect of the present disclosure, a microwave oven system is provided which comprises a remote computing device having a display, and a microwave oven, wherein the microwave oven comprises a housing having an internal heating chamber, a microwave radiation generator, at least one infrared thermal imaging camera having a field of vision in the heating chamber, wherein the at least one infrared thermal imaging camera generates a set of temperature signals, each temperature signal having a value and corresponding to a location within the field of vision, and a wireless transceiver, wherein the wireless transceiver receives the set of temperature signals from the at least one infrared thermal imaging camera and transmits (typically via an intervening device such as a router) wireless signals corresponding to the set of temperature signals to the remote computing device, the remote computing device comprises a display, a central processing unit and at least one non-transitory computer readable medium having computer executable instructions stored thereon, and wherein the display is selectively operable to display colors corresponding to the value of each temperature signal in the set of temperature signals at locations on the display which correspond to the locations in the field of vision to which the temperature signals in the set of temperature signals corresponds.

In accordance with a fourth aspect of the present disclosure, a method of using crowdsourced cooking parameters to cook a food item comprises providing a microwave oven comprising a cooking controller, providing a food item, transmitting food item identification data for the food item to a central processing server, receiving at least one cooking parameter from the central processing server, wherein the at least one cooking parameter corresponds to the food item, and adjusting a setpoint of the cooking controller based on the received at least one cooking parameter.

In accordance with a fifth aspect of the present disclosure, a method of generating crowdsourced cooking parameters comprises providing a server connected to a network, wherein the network is connected to a plurality of microwave ovens; receiving a plurality of cooking event data sets from the plurality of microwave ovens, wherein each cooking event data set comprises food identification data and at least one of cooking time data and food temperature data; and determining a target cooking event data set comprising at least one cooking parameter based on the received plurality of cooking event data sets.

In accordance with a sixth aspect of the present disclosure, a microwave oven is provided which comprises a housing comprising an internal heating chamber, a microwave radiation generator, a rotating platter, at least one sensor selected from the group consisting of an optical camera, a weight sensor, a rotating platter position sensor, a rotating platter speed sensor, a humidity sensor, an infrared thermal imaging camera, and a microphone, and a controller, wherein the controller is programmed to receive a sensor signal having a sensor signal value from the at least one sensor and adjust a cooking parameter based on the sensor signal value.

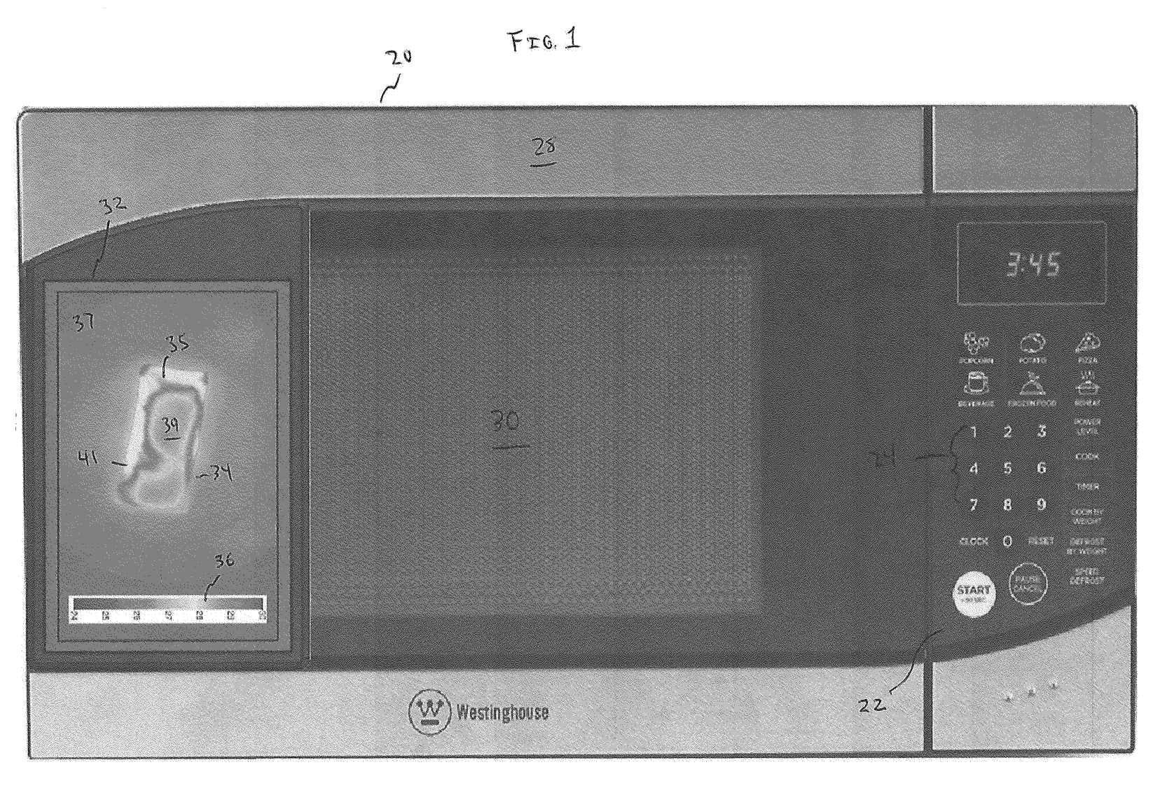

Referring to FIG. 1 a microwave oven 20 is depicted. Microwave oven comprises a door 28, a window 30, a control panel 22, and a display 32. Control panel 22 includes a keypad 24. The buttons are configured as “soft keys” and also include number of conventional buttons (soft keys).

Display 32 is provided on a side of door 28 that is spaced apart from the control panel 22 along the width dimension of the microwave oven 20. Display 32 is configured to selectively display a heat map 34. Heat map 34 is a color-coded temperature map of the food item being cooked in microwave oven 20, and in the illustrated example is a burrito. As explained further below, known infrared cameras generate color-coded temperature maps based on infrared radiation emitted from an object within the camera's field of view. Each pixel of the display is illuminated with a color that corresponds to a temperature in the microwave oven 20. The food item being cooked (the burrito) responds to the microwave energy of the microwave oven to a much greater degree than the interior of the oven itself. Thus, the areas of the microwave internal heating chamber in which the burrito is present 35 appear yellow and red, which are hotter than surrounding areas 33 which are green and blue. A scale 36 at the bottom of display 32 shows the relationship between different colors on the display 32 and the temperatures that they represent with blue at the far left representing the coldest temperature and red at the far right representing the hottest temperature. In this case, the heat map 34 indicates that a central portion 39 of the burrito is relatively colder than a perimeter portion 41 of the burrito. Display 32 is preferably a touchscreen used as a user interface which may supplement or replace control panel 22. Display 32 or buttons in the control panel 22 may be configured to selectively display the heat map 34 as desired by a user. In certain examples, the entire door 28 could be configured as an LCD touch screen. The microwave 20 could be configured to automatically perform certain display functions based on certain events. For example, if a proximity sensor is provided, the display 32 could display control buttons (soft keys) when a user is within a certain distance of microwave 20 and display pictures otherwise. Once a cooking event is underway, display 32 could automatically display heat map 34, a stop button, and a time increment button (used to incrementally increase the cooking time by a specified amount such as 30 seconds). In certain examples, the microwave 20 may also be configured to display cooking recipes and videos while a user is cooking in the kitchen. In one example, microwave 20 may run on the Android operating system and the user could access Pinterest or a favorite recipe app.

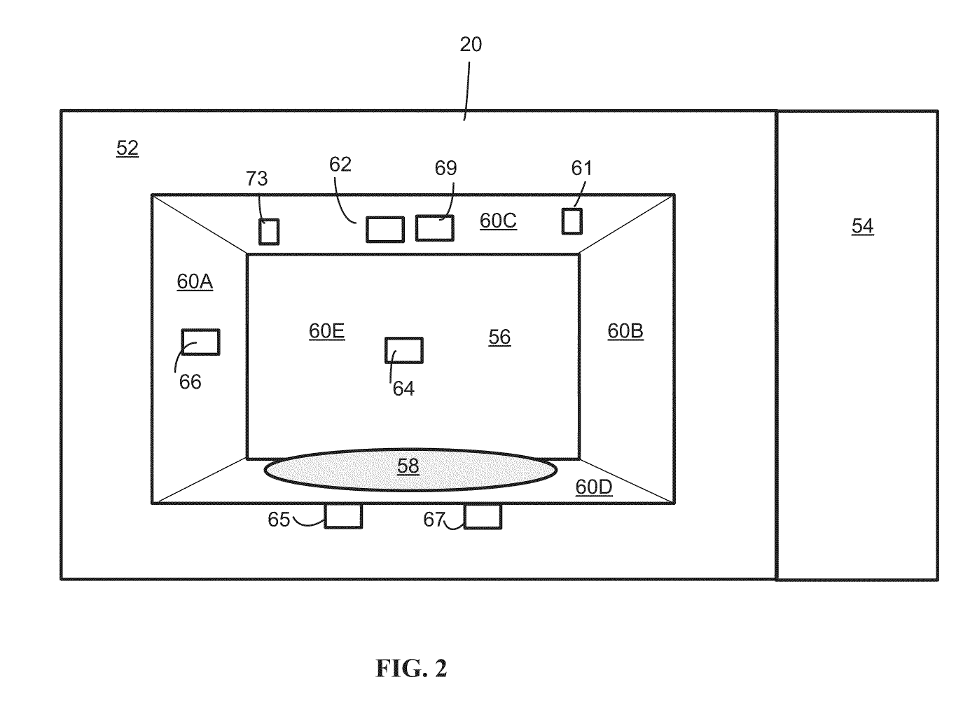

Heat map 34 is generated by one or more infrared thermal imaging cameras. Referring to FIG. 2, the interior of microwave oven 20 is shown (door 28 is removed). Housing 52 includes a microwave generator section 54 which houses a magnetron for generating microwaves and transmitting them into the internal heating chamber 56.

Sidewalls 60A and 60B, door 28, upper wall 60C and lower wall 60D, and back wall 60E collectively define internal heating chamber 56. Internal heating chamber 56 is where food is placed for cooking. Platter 58 is provided and is selectively rotatable to rotate a food item as it is subjected to microwave radiation during a cooking event. At least one infrared thermal imaging camera is provided in the internal heating chamber 56. In the illustrated example, three infrared thermal imaging cameras 62, 64, and 66 are shown. If only one infrared thermal imaging camera is provided, it is preferably located and centered on upper wall 60C. If only two infrared thermal imaging cameras are provided, they are preferably located on upper wall 60C and back wall 60E. If three infrared thermal imaging cameras are provided, they are preferably located on upper wall 60C, back wall 60E, and side wall 60A.

The infrared thermal imaging cameras 62, 64, and 66 may be used to create heat map 34. A thermal infrared imaging camera includes a lens that focuses infrared radiation emitted by objects in the camera's field of view. The focused infrared radiation is incident to an array of infrared detector elements that create a 2-D temperature pattern called a thermogram. Each array element has an electrical resistance associated with it, and the resistances are measured by applying a bias voltage and integrating the resulting current for a finite period of time for each array element. The integrated current for each array element is sent to a signal processing unit that translates the the integrated current values into display data, where they appear as colors that correspond to the values of the detected resistances and integrated current values. Thus, each array element has a row (x) and column (y) associated with it and an electrical signal value that may vary with time, i.e., T=T(x,y,t). Each array element also corresponds to an x, y location in the infrared thermal imaging camera's field of view. Suitable infrared thermal imaging cameras for use in the microwave ovens described herein include but are not limited to the FLIR Lepton® longwave infrared imager (LWIR) supplied by FLIR Systems Inc. of Wilsonville, Oreg. The FLIR Lepton® has a resolution of 80×60 active pixels (4800 pixels total) and has a thermal sensitivity of less than 50 mK (milli Kelvin). It is available with both a 50 degree and 25 degree nominal field of view. It senses infrared radiation in a nominal response wavelength band of from 8 to 14 microns and includes SPI video interfaces. Other infrared thermal imaging cameras may also be used. The FLIR Lepton® is merely exemplary. The images provided by infrared thermal imaging cameras may be static or dynamic (i.e., video), and the word “image” as used herein refers to static and/or dynamic images.

Referring again to FIG. 2, infrared thermal imaging cameras 62, 64, and 66 are respectively mounted on internal heating chamber walls 60C, 60E, and 60A. The cameras 62, 64, and 66 may be much smaller than depicted. For example, the FLIR Lepton® is 8.5×11.7×5.6 mm without a socket and 10.6×11.7×5.8 mm with a socket.

Cameras 62, 64, and 66 are preferably operatively connected to display 32 so that heat map 34 may be selectively displayed on display 32. If multiple infrared thermal imaging cameras 62, and 64, and 66 are used, the display 32 may be configured to display each of their respective images independently. In addition, the images from each camera 62, 64, and 66 may be composited. The composite may also be used to create a rotating three-dimensional thermal image using algorithms such as a structure from motion (SFM) algorithm or a scale-invariant feature transform (SIFT) algorithm. Commercially available programs for creating three-dimensional, rotating images from multiple camera images include Microsoft Photosynth, Autodesk Photofly, Bundler, and VisualSFM (Visual Structure from Motion).

At least one optical camera such as optical camera 69 may also be provided in the internal heating chamber 56. Image data provided by optical camera 69 may be static or dynamic (i.e., video), and as used herein, the phrases “optical images” and the like refer to static and/or dynamic images. In certain examples, three optical cameras are used and are placed adjacent one of each of the infrared thermal imaging cameras. In FIG. 2, optical camera 69 is mounted on upper wall 60C of internal heating chamber 56. However, other mounting locations may also be used. Optical camera 69 detects visible light and transmits the visible light images to display 32, where they may be selectively displayed. In certain examples, display 32 is configured to display a food item's heat map 34 next to the food item's optical image. Suitable optical cameras 69 are known to those skilled in the art and include, as but one example, the Omnivision OV5647 5 Megapixel Image Sensor, supplied by Omnivision Technologies, Inc. of Santa Clara, Calif. Optical camera 69 is particularly useful with foods that exhibit a visual change while heating such as melting cheese or boiling water.

In certain implementations, display 32 is also configured to generate an outline of the food item being cooked based on image data from the optical camera 69 and superimpose a heat map 34 for the food item on the outline. Display 32 may also include soft keys for executing control functions, menus, and may also be configured to display a web browser for accessing web pages in the Internet. When the microwave oven 20 is not used for cooking, display 32 may display pictures or other stored files like a digital picture frame of the type that is currently available. The displayed files may be stored locally or on a locally-networked or remote server. In certain implementations, the displayed files are stored in a remote server and accessed via the Internet.

Other types of sensors may also be included in microwave oven 20. For example, a microphone 73 may be provided and used in connection with foods that provide an audible indication of cooking progress (e.g., popcorn). Hygrometer 61 may also be provided to indicate the humidity in the internal heating chamber 56. Suitable hygrometers include the Sensirion SHT21 humidity sensor supplied by Sensirion AG of Switzerland. Display 32 may be configured to display decibel levels from microphone 73 and/or humidity levels from hygrometer 61. In certain examples, a weight sensor 65 is added to the bottom wall 60D of microwave oven 20 and used by a suitable controller to determine if cooking is complete based on a decrease in the sensed weight. In certain examples herein, the hygrometer 61 data, rotational platter position and/or speed sensor 67 data, and/or weight sensor 65 data is dynamic (i.e., the sensor values are provided with associated time stamps) so that dynamic sensor profiles are provided.

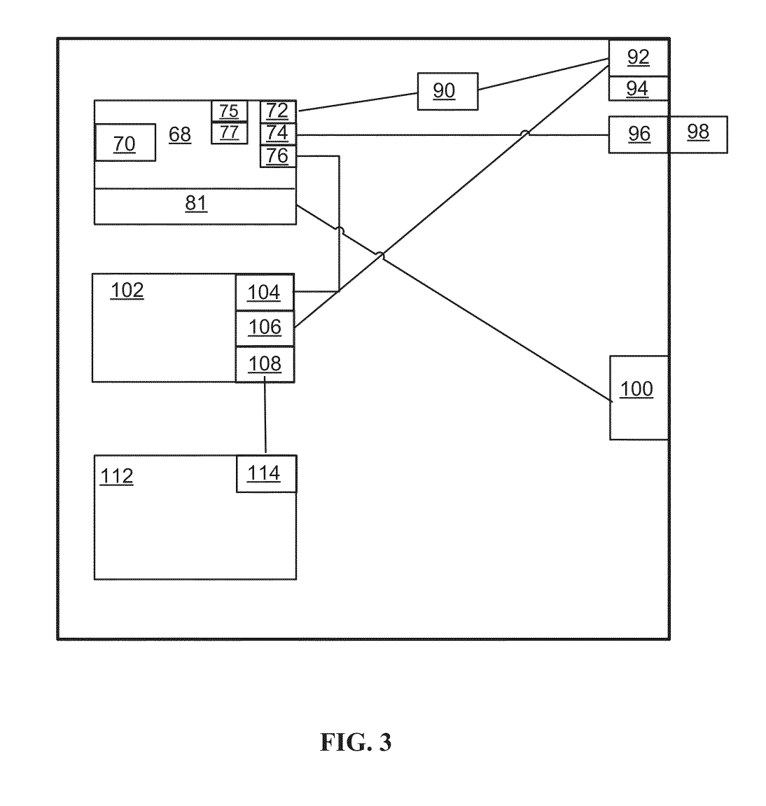

Microwave oven 20 preferably includes a computing and control module. The computing and control module includes a central processing unit (CPU) and a memory as well as suitable input-output interfaces. Referring to FIG. 3, an exemplary electrical schematic for microwave oven 20 is depicted. Computing and control module 68 includes non-volatile memory 70, a power input connector 72, USB ports 74, a display port 76, and a GPIO (general purpose input output) section 81 comprising a number of GPIO pins. Computing and control module 68 also includes a CPU 75 and random access memory (RAM) 77. Computing and control module 68 may also include a camera interface (CSI) and a display interface (DSI) as well as a graphics core. One example of a suitable computing and control module 68 is a Texas Instruments AM3358 industrial microprocessor. An infrared thermal imaging camera breakout board 100 connects the infrared thermal imaging cameras 62, 64, and 66 to the GPIO section of computing and control module 68. Although not depicted, in preferred examples, the computing and control module 68 has outputs connected to the power circuit or a power level circuit for the microwave so that the computing and control module 68 can terminate a cooking event when a desired temperature is reached and/or adjust the power level as needed. This will allow the computing and control module 68 to function as a food item cooking controller that uses data such as temperatures provided by the infrared thermal imaging cameras 62, 64, and 66, audio signals from microphone 73, humidity measurements from hygrometer 61, and/or measurements from weight sensor 65 as control variables. If optical camera 69 (or multiple optical cameras) is provided, it may also have a suitable interface that connects it to the computing and control module 68 and may be used for control purposes, wherein real time images are compared to database images and the comparison is used to adjust a cooking parameter. For example, if boiling is observed, the power level could be adjusted or cooking power could be turned off.

Microwave oven 20 also includes an LCD interface board 102 comprising a display input 104, a 12V power input connector 106, and an LVDS and power connector 108. LCD screen 112 includes an LVDS and power connector 114.

A 12V to 5V DC to DC converter 90 connects a panel mount barrel jack 92 to the power input connector 72 of computing and control module 68 and is connected to a chassis ground point 94. A WiFi transceiver 96 and antenna 98 are included for transmitting and receiving WiFi signals so that microwave oven 20 may be wirelessly connected to computing networks such as the Internet.

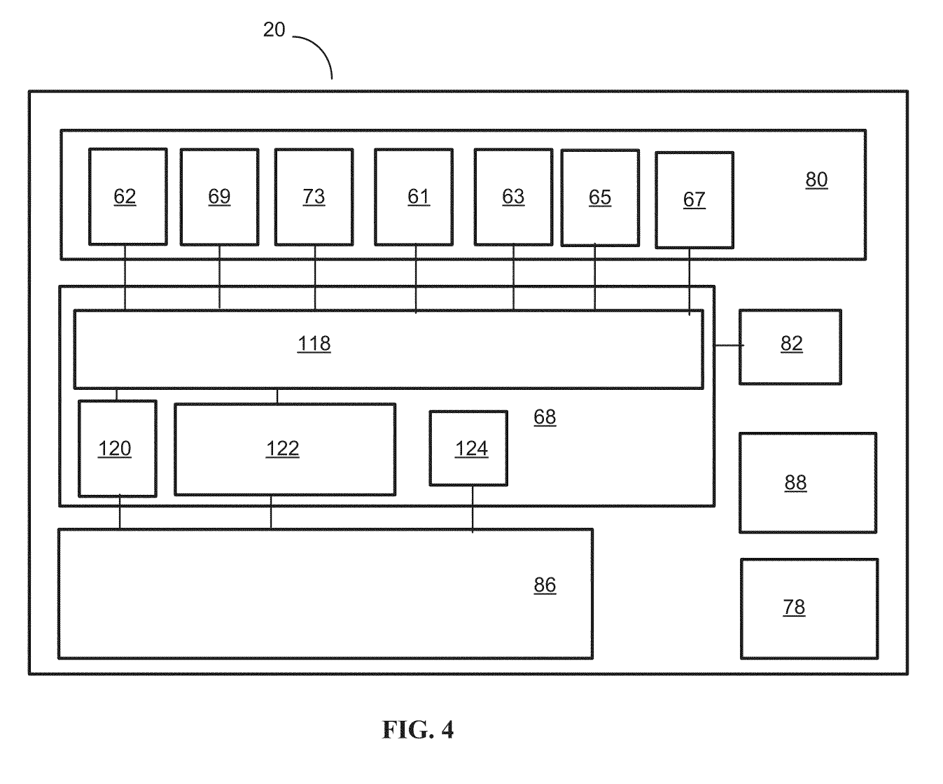

FIG. 4 is a functional schematic of the computing, display, control, and data processing functions of microwave oven 20. Traditional microwave function module 124 provides power level adjustment and heating functions (i.e., heating ON or OFF) and is connected to display module 86 which provides the display functions implemented on display 32. The display module also performs the functions of the control panel 22 described previously and displays heat map 34 and temperature scale 36 on the display 32.

Power supply module 78 receives the main power input and supplies it to different electronic components in microwave oven 20. Microwave power driver 88 circuitry includes traditional microwave circuitry for operating a light (not shown) in the internal heating chamber 56, the magnetron (not shown) and a turntable that rotates rotating platter 58.

Sensor module 80 includes an infrared thermal imaging camera 62 that provides spatially and time variant temperature values T=f(x,y,t) and thermographic images to a sensor fusion module 118 in computing and control module 68. Optical camera module 69 provides visual images to sensor fusion module 118, and microphone 73 provides audio data to sensor fusion module 118. Hygrometer 61 provides humidity data to sensor fusion module 118, and current sensor 63 provides instantaneous power consumption data to sensor fusion module 118. Weight sensor 65 and rotational platter position and/or speed sensor 67 provide their respective data to sensor fusion module 118 as well. The sensor fusion module 118 is part of the computing and control module 68 receives and processes data from the various cameras and sensors 61, 62, 63, 69, 73, 65 and 67 for use in various data processing and control functions. The sensor fusion module 118 is typically implemented as software resident on non-volatile memory 70 of computing and control module 68 for execution by the computing and control module CPU 75. Exemplary functions carried out by the sensor fusion module 118 include converting temperature data to displayable color images and calculating various averages, standard deviations, and other statistical parameters for the received sensor signals.

Graphics module 120 performs various graphics functions on sensor and image data. It may also be used to generate composite images from multiple camera images as described previously.

The heat map 34 can be used for open-loop temperature control in which a user determines when cooking is complete based on the color distribution in the heat map 34. In certain examples, pre-packaged foods may be provided which include pre-printed heat maps on their packaging, and users may compare the heat map 34 to the heat map appearing on the packaging to determine when a food item is sufficiently. In other examples, microwavable food packaging may be configured with a temperature indicating feature such as a strip of material that reaches a certain temperature when the food in the packaging is done. For example, a strip of material may be provided which appears white on the heat map 34.

Autonomy module 122 acts as a software-implemented cooking controller. It receives user-entered cooking parameter setpoints (such as desired cooking temperatures) or cooking parameter setpoints from central processing server 134 (described below). The autonomy module 122 compares a measured variable (such as various temperatures from the infrared thermal imaging cameras 62, 64, 66 or averages thereof) to such setpoints and adjusts a cooking parameter to based on both the setpoint and the measured variables. The term “cooking parameters” includes variables that may be adjusted to carry out a desired cooking operation, including cooking time, power level, food item temperature, rotational platter 58 rotational position, rotational platter 58 rotational speed, humidity, and food weight. Cooking parameters may be adjusted as part of a cascade control scheme wherein a secondary cooking parameter controller (i.e., a temperature controller) adjusts a cooking time or power level controller to carry out a cooking operation.

Autonomy module 122 may use a variety of different control algorithms to carry out a cooking operation. For example, a user may input a desired maximum food item temperature setpoint via microwave control panel 22, and the autonomy module will shut off the cooking power (i.e., turn the cooking power OFF such that bombardment of the internal heating chamber 56 with microwave energy ceases) when any of the food item temperatures provided by any of the infrared thermal imaging cameras 62, 64, and 66 exceeds the maximum set point. Alternatively or additionally, the user may input a minimum temperature set point, and the autonomy module will keep the cooking power on until all measured temperatures on the food item exceed the setpoint. Alternatively or additionally, the autonomy module 122 may calculate an average or weighted average food item temperature value based on the temperatures provided by the infrared thermal imaging cameras 62, 64, and 66 and shut off the cooking power when the calculated average reaches or exceeds a setpoint provided by the user or the central processing server 134. The autonomy module 122 may also use the microphone 73 to control the cooking power (turn it ON or OFF or adjust the power level) based on the occurrence of certain audible cooking events. In certain implementations, autonomy module 122 may filter out audio signals received from microphone 73 which are below a certain decibel threshold because they are not indicative of cooking progress. In the same or other implementations, the autonomy module 122 may be programmed to turn off cooking power when a certain time threshold between audible signals of a given level is reached. In the case of cooking popcorn, for example, when audible pops are detected at 1-2 seconds apart, cooking could be terminated. In addition, a high audio signal override may be used which terminates cooking if a particularly high decibel level is reached which is indicative of a high pressure event, such as a top coming off of an enclosed container.

In one example, autonomy module 122 maintains the cooking power on until a specified percentage of the food item temperature values provided by the infrared thermal imaging cameras 62, 64, 66 reaches or exceeds a specified value. In one illustrative example, a user inputs a setpoint of 165° F. and the autonomy module 122 shuts the cooking power off only after 80 percent of the food item temperature values exceed 165° F.

Each infrared thermal imaging camera 62, 64, 66 array element may be referred to as a “pixel” (picture element) because it can be used to create a thermographic image. However, for ease of reference, “pixel” will also be used herein to refer to the temperature measurement at a particular array location in the infrared thermal imaging camera 62, 64, 66. As mentioned previously, the FLIR Lepton® has an array of 4800 active pixels. In certain preferred examples, the autonomy module 122 is programmed to determine which pixels P(x,y,t) are indicative of a temperature of a food item in the field of view of each infrared thermal imaging camera and which pixels are not indicative of a food temperature.

For example, if one camera 62 is used, at any one time, part of the field of view of camera 62 will include a food item and part of the field of view will include the interior of the microwave where the food item is not present. Referring to heat map 34 in FIG. 1, region 35 includes the areas where the burrito being cooked is present, and region 37 includes areas of the internal heating chamber 56 where the burrito is not present. For purposes of controlling the cooking of the burrito or developing crowdsourced cooking temperatures, the temperature measurements for region 37 should be excluded.

In one example, the temperature rise of individual pixels is tracked and used to determine whether the pixel temperature is indicative of the presence of a food item. Pixels corresponding to food item locations in fields of view of the infrared thermal imaging cameras 62, 64, 66 would be expected to experience a faster temperature rise than pixels corresponding to regions of the fields of view where the food item is not present because plates and the surfaces of the internal heating chamber walls 60A-60E are preferably formed from a material that experiences little or at least insignificant heating in response to microwave energy. Microwave energy typically heats up food by causing polarized molecules in the food to rotate and build up thermal energy in a process known as dielectric heating. Microwave-safe plates and internal microwave surfaces such as those of chamber walls 60A-60E which define the internal heating chamber 56 do not heat up appreciably in response to bombardment with microwave energy because they are reflective to microwave radiation. Even those plates that are not microwave-safe will typically have a dynamic temperature profile that differs significantly from food items such that pixels corresponding to food item locations can be readily distinguished from those not corresponding to food item locations. Thus, in one example, a set of computer executable instructions (comprising part of autonomy module 122) are resident in a computer readable memory of computer and control module 68 is executed, and the instructions carry out the steps of reading temperature values in the field of view of each infrared thermal imaging camera 62, 64, and 66 during a specified period of time and using the dynamic temperature measurements to determine if a food item is present at a particular x, y location in the field of view of the particular infrared thermal imaging camera 62, 64, 66. Only those pixels corresponding to locations where food is present are used for generating crowdsourced temperatures and for performing cooking control operations. As noted below, whether a particular location within the field of view is one at which a food item is present may vary with time if the food item is rotating on platter 58. In some cases, specified rates of temperature change may be used to determine if a food item is present at a given location. In other cases, measured temperature profiles may be compared to those in a database to determine if a food item is present.

In other examples, object recognition software may be provided (as part of autonomy module 122) which uses optical images from optical camera 69 to determine whether the food item is present at a particular pixel location in the field of view of a given infrared thermal imaging camera 62, 64, 66. Thus, computing and control module 68 may have computer executable instructions stored in its non-volatile memory 70, which, when executed by the CPU 75, determine which pixels correspond to a food item temperature. A local or remote database may store an optical image of the internal heating chamber 56, and the autonomy module 122 may be programmed to compare that image to an image generated with food present in the internal heating chamber. A pixel by pixel comparison of the database image and the actual image can be used to determine those pixel locations at which the food item is present.

As mentioned previously, microwave oven 20 may include a rotating platter 58 which rotates a food item during a cooking event. When a food item is rotated, the relationship between physical locations on the food item and locations in the field of view of a given infrared thermal imaging camera 62, 64, and 66 will vary dynamically. Thus, at any one time a particular array location of the infrared thermal imaging camera 62 (or additional cameras if provided) may or may not correspond to a location on a food item. Therefore, if a dynamic heating profile is to be developed or if historical temperature data is to be maintained for unique locations on the food item, it is necessary to relate those food item locations to the fixed locations on 2-D the infrared thermal imaging camera 62, 64, 66 arrays. To do this, pixel tracking algorithms may be employed as part of autonomy module 122 which track the movement of each food item pixel P(x_{f}, y_{f}, t) as the food item rotates on platter 58. Such algorithms may use known relationships between the speed of movement of a point on a rotating circle and techniques for relating polar and Cartesian coordinates to dynamically determine which infrared thermal imaging camera array pixel location (x,y) corresponds to a given a food item pixel location x_{f}, y_{f}. In general, for a rotating food item, each pixel will have a position that varies with the rotational speed of the platter 58 and the distance of the pixel from the center of rotation of the platter 58. Thus, at any one time, a food item pixel location x_{f}, y_{f} will correspond to a particular infrared thermal imaging camera array location x,y so that the temperature measurements of the infrared thermal imaging camera can be dynamically correlated with correct pixel locations x_{f}, y_{f} on the food item. In other examples, the rotating platter 58 may be connected to an encoder that indicates the rotational position of the rotating platter relative to a defined starting point (0 degrees rotation). The position signal could be used by the autonomy module 122 to dynamically determine which infrared thermal imaging camera array location (or element) corresponds to which location on the food item. Also, the rotational position could itself be used as a manipulated variable. For example, if the infrared thermal imaging cameras determine that there are hot or cold spots on a food item, the rotational position of the food item could be automatically adjusted to achieve a desired distribution. A speed sensor 67 may also be used to detect the speed of rotation of the rotating platter so that the speed may be adjusted to achieve a desired temperature distribution. Rotational speed sensor 67 may also be used to sense rotational position, or in certain examples, separate sensors may be used to sense the rotational speed and rotational position of the platter 58.

In addition, graphics module 120 may be programmed to transform the rotating image into a static thermal image of the food item by relating each food item pixel P(x_{f}, y_{f}, t) to a fixed display unit pixel P(x_{d}, y_{d}, t) on display 32 as the food item rotates.

Wireless signal module 82 acts as a wireless transceiver to transmit and receive wireless signals to and from wireless devices. As described below, in some implementations, a user may view certain display functions or execute control actions using a remote computing device such as a watch, desktop computer, laptop computer, tablet computer, or smart phone. The word “remote” indicates that the computing device is not directly connected to the microwave oven 20 and is instead connected via a local or wide area network (including the Internet). The wireless signal module uses known wireless signal protocols (e.g. Bluetooth, WiFi, Zigbee, etc.) to communicate with such remote devices via networks, such as the Internet. In addition, the wireless module 82 may be used to communicate with a central processing server 134 (described below). Although not shown, the microwave oven 20 may also connect to the Internet or other networks via a standard Ethernet connection.

In certain examples, autonomy module 122 is used to regulate access to user specific cooking data by providing users with a credentialed account linked to data for past cooking events. Such data may include optical images, heat maps, historical temperature data, hygrometer data, weight data, energy usage, and audio files (recorded from microphone 73).

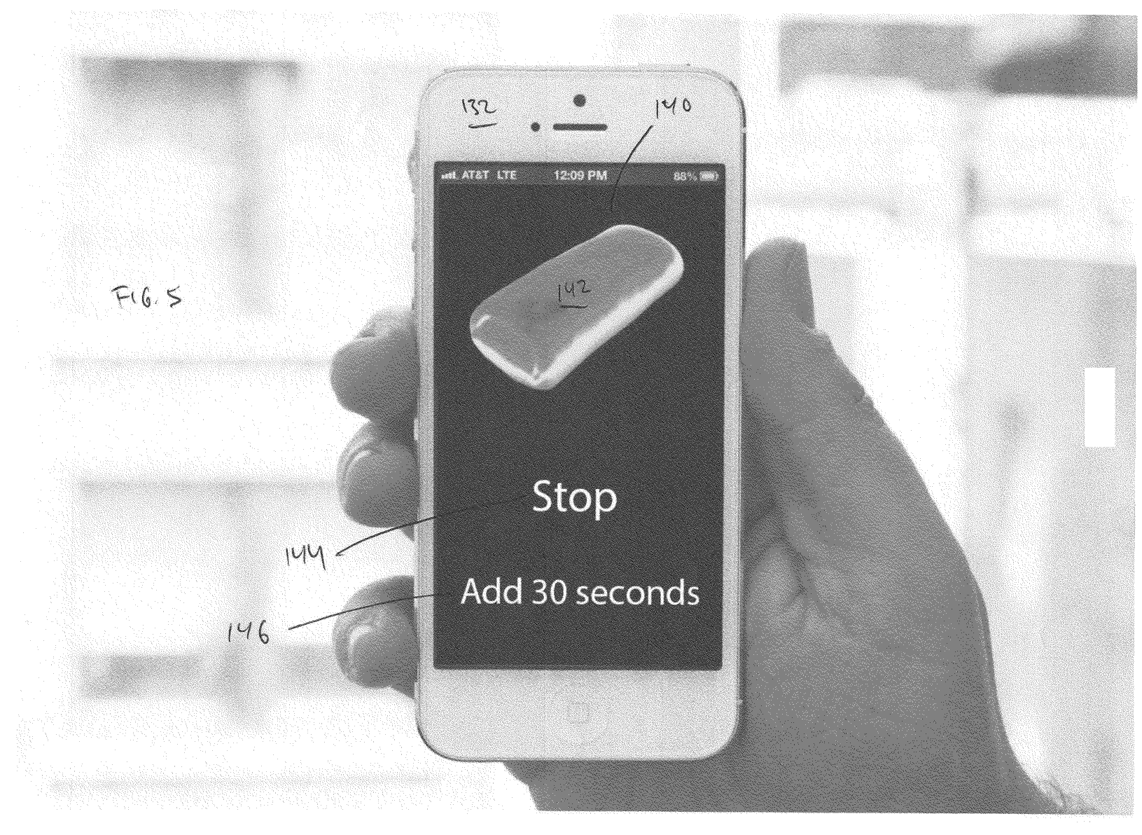

Referring to FIG. 5, a mobile remote computing device is depicted which in the illustrated embodiment is smart phone 132. Desktop, laptop, and tablet computers may also be used to receive data and images from microwave oven 20 and to execute control functions on microwave oven 20.

Smart phone 132 is configured to communicate with microwave oven 20 via the Internet. Smart phone 132 includes a central processing unit and a non-volatile storage device on which computer executable instructions are stored. When executed by the central processing unit, the computer executable instructions display microwave control interface 140 on the smart phone display. The microwave control interface includes a heat map 142 which is generated in the same fashion as the heat map 34 described previously. Microwave cooking power control button 144 is a soft key on the microwave control interface 140 which allows a cooking even to be terminated or initiated in microwave oven 20. Timer button 146 is a soft key on the microwave control interface 140 which allows the user to adjust the cooking time during which the cooking power remains on. Using appropriate protocols to communicate with a specific microwave oven 20, smart phone 132 communicates with the wireless module 82 (FIG. 3) to transmit commands or control set points to microwave oven 20 and to receive display information for microwave control interface 140. Thus, a user can walk away from microwave oven 20 and perform other tasks while remotely monitoring the heat map 142 and adjusting the cooking time with button 146 or terminating a cooking event with button 144. Heat map 142 provides a remote indication of the spatial heating profile of the food item which the user can use to make decisions about continuing or ending a cooking event or adjusting another cooking parameter such as the power level.

In certain examples, video signals from the infrared thermal imaging cameras 62, 64, 66 and the optical camera 69 are streamed to the microwave control interface 140 of smart phone 132 or other remote device. For example, video may be streamed over a network connection and then made available via network connection to local devices connected to a router so that the video may be used by an application on a smartphone or tablet or by a program on a desktop or laptop computer.

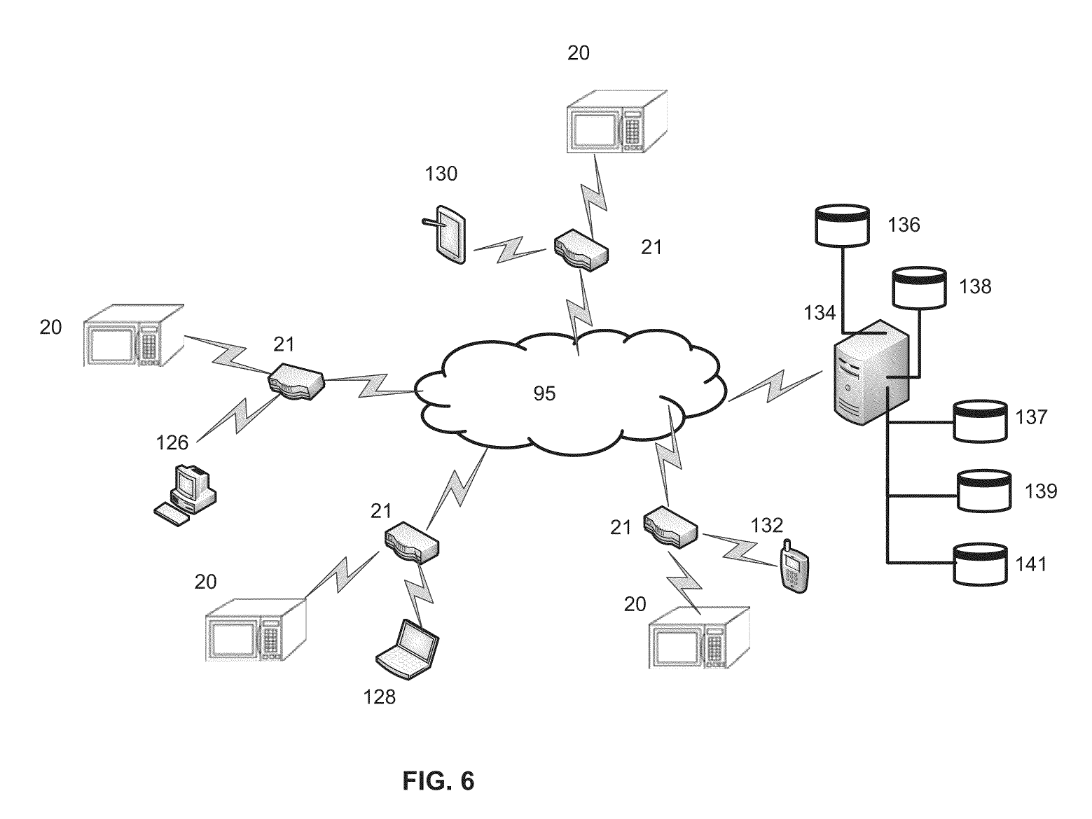

As indicated previously, in certain implementations, microwave oven 20 is configured to receive cooking parameters from a remote server. In some cases, it may be desirable to use a crowdsourcing technique to aggregate cooking event data from a number of cooking events and develop a model or set of preferred or optimum cooking parameters. Referring to FIG. 6 a crowdsourced cooking system is depicted. The system comprises a plurality of microwave ovens 20 which are operated by geographically dispersed operators who may be located in different cities, counties, states, or countries. Microwave ovens 20 area each wirelessly connected to the Internet 95 via respective wireless routers 21. Remote connected devices such as computers 126, laptops 128, tablets 130, and smart phones 132 are also connected to the network via routers 21 and are configured to remotely control and/or receive data from selected ones of the microwave ovens 20 via the Internet 95 and the routers 21.

Central processing server 134 is also connected to the Internet and includes a central processing unit, random access memory, and non-volatile storage for storing a variety of different computer programs. The central processing server 134 is connected to an optical image database 136, a temperature profile database 138, an audio database 137 (containing wave files of sounds corresponding to the cooking of food items as generated from a microphone such as microphone 73), a weight database 139, and a humidity database 141, which may be used in any combination to identify a food item and corresponding cooking parameters from corresponding cooking event data provided by the sensors in microwave oven 20. Each database 136, 137, 138, 139, 141 may correlate sets of static or dynamic cooking event data to one or more food item identifiers. Each set of cooking event data in each database 136, 137, 138, 139, 141 may correspond to multiple food items or a single food item. In cases where a given set of cooking event data corresponds to multiple food items, several or all of the databases 136, 137, 138, 139, 141 may be used to determine which food item is most likely being cooked by the microwave oven 20 supplying the data. Although the databases 136, 137, 138, 139, 141 are illustrated as being provided on separate non-volatile storage media in FIG. 6, they may be configured in a variety of ways, including on a single non-volatile computer readable storage medium.

In certain examples, microwave ovens 20 are configured to receive crowdsourced cooking parameters for display and/or as control set points, from central processing server 134. In addition, central processing server 134 is configured to receive cooking event data from microwave ovens 20 (which may number in the 100s, 1000s or greater) and to generate a cooking parameter model by statistically analyzing the received cooking event data to develop preferred values of cooking parameters such as temperatures, power levels, and/or cooking times. In this way, individual users can leverage the collective cooking experiences of other users of the crowdsourcing system in order to more optimally cook food items. As more data is collected, by the crowdsourcing system, the sets of crowdsourced cooking parameters will become increasingly accurate.

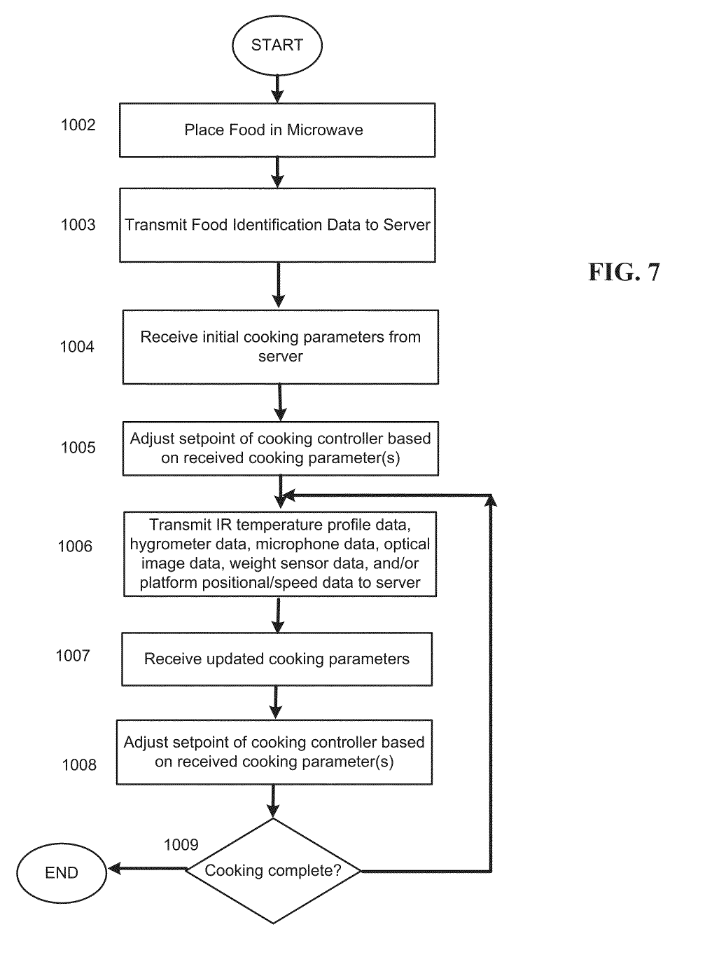

FIG. 7 is a flow chart depicting a method of crowdsourced cooking. In accordance with the method, a user places a food item in microwave oven 20 (step 1002). The crowdsourced cooking model is preferably tailored to specific food items. Thus, the user then transmits food identification data to central processing server 134 (step 1003). This step can be performed in a number of different ways. For example, the user could input alphanumeric text on the display 32 or with the key pad 24. In addition, the food-specific control icons 38 could be used to communicate a food identifier to central processing server 134.

In addition, automated techniques for transmitting food identification information may be used. When pre-packaged food items are used, a bar code or QR code could be provided on the packaging and scanned with the bar code encoding a food identifier. The optical camera 69 may also be used to capture an image of the bar code or QR code for subsequent decoding.

Another technique for performing step 1003 is to use at least one or any combination of optical image data, dynamic temperature profile data, audio data, hygrometer (humidity) data, and weight data to identify the particular food item (each of these types of data may be referred to as “food identification data”). Optical image database 136, dynamic temperature profile database 138, audio database 137, humidity database 139, and weight database 141 may correlate sets of cooking event data to a particular food item identified by a food item identifier. In some cases, the same set of data in a given database may correspond to multiple food items, and the querying of multiple databases among the databases 136-139 and 141 may resolve which food item is actually being cooked by the microwave oven 20 transmitting data to the central processing server 134.

In one illustrative example, optical image database 136 (FIG. 6) is operatively connected to central processing server 134. The optical image database 136 comprises optical image data sets, each of which is related to a particular food item. Using optical camera 69, the autonomy module 122 transmits optical images of the food item in the internal heating chamber 56 (which may be filtered to exclude portions of the image where the food item is not present) to central processing server 134. Using the optical image data as a query key, the central processing server 134 executes certain programs to query optical image database 136 and identify the food item corresponding to the received optical image data.

In another illustrative example, the user starts cooking a food item in microwave oven 20 using pre-selected nominal cooking parameters (e.g., a power level of 100 and a preliminary cooking time of 30 seconds). The user can enter the power level and cooking time directly or just press a single button configured to initiate cooking at a predetermined power level for a predetermined period of time. During the preliminary cooking time, the autonomy module 122 collects historical temperature data for specific food item pixel locations x_{f}, y_{f}. The techniques described previously are used to ensure that specific pixel locations of the infrared thermal imaging cameras 62, 64, 66 are those at which food is present and/or to dynamically track food item pixel locations x_{f}, y_{f} if the food item is rotating on platter 58. The historical data for the pixels P(x_{f}, y_{f}, t) is transmitted to the central processing server 134, which executes comparison programs that compare the historical data P(x_{f}, y_{f}, t) to the dynamic profiles stored in a temperature profile database 138 to which the central processing server 134 is operatively connected. For purposes of comparison, the spatially varying pixel data may be converted to an appropriate average (standard average, weighted average based on appropriate weighting factors, etc.). Thus, the temperature profile data provided by the microwave oven 20 is used as a query key in the temperature profile database 138 to determine the corresponding food item. Similar techniques can be used for the audio database 137, humidity database 139, and weight database 141.

Once the food item is identified in step 1003, central processing server 134 may select an appropriate set of initial cooking parameters (which may comprise one parameter) corresponding to the food item and transmit it to the microwave oven 20 that is cooking the item. The set of initial cooking parameters is received by the microwave oven 20 in step 1004. In addition, the sets of cooking parameters may be further organized based on the make and/or model of the particular microwave oven 20, since many microwave ovens will differ as to their cooking characteristics. The cooking parameters may comprise cooking temperatures, cooking times, rotational platter positions, rotational platter speeds, and/or power levels. In certain implementations, step 1003 may be carried out based only on data generated before cooking begins (i.e., optical image data from camera 69 or weight data from weight sensor 65), and in step 1004 an identification of the food item from sensor data generated during cooking (e.g., initial infrared thermal imaging camera 62 temperature data or optical images and weight data generated after cooking begins) may be used to provide a second identification of the food item and a second identification of cooking parameters).

In step 1005 a cooking controller setpoint (e.g., a controller configured as software in autonomy module 122) is adjusted based on the cooking parameter(s) received from central processing server 134 in step 1004. In one implementation of step 1005, autonomy module 122 may comprise a temperature controller that terminates cooking power when a particular temperature reaches a set point provided by the central processing server. In one example, the central processing server 134 determines an average or weighted average temperature for a particular food item and transmits that temperature to a microwave oven 20. The temperature is then used as a set point in a controller configured in autonomy module 122. In certain examples, the user may enter the received average or weighted average temperature using a remote computing device, LCD display 34 or key pad 22. In other examples, a program resident in the computing and control module 68 (and which is functionally part of the autonomy module 122) may execute to automatically update the setpoint.

The autonomy module 122 calculates a corresponding average temperature based on the data provided by infrared thermal imaging cameras 60, 62, 64 and keeps the cooking power on until the average reaches the set point provided by the central processing server 134. One benefit to using temperature instead of cooking time and power level (as discussed below) is that it may avoid the need for segregating cooking parameter data based on microwave oven make and model because the temperature of the food item is significant in determining whether the food item is cooked regardless of the particular microwave used to reach that temperature.

In another example of step 1005, the central processing server 134 may determine a statistical average of the cooking times used during a number of cooking events to cook a particular item and may transmit that statistical average cooking time as a cooking parameter to a microwave oven 20. The received cooking time may then be used as a set point to a cooking timer such that the autonomy module 122 terminates cooking power when the elapsed cooking time reaches the cooking time provide by the central processing server 134. In certain examples, the user may enter the cooking time using a remote device 132, LCD display 32 or key pad 22. In other examples, a program resident in the computing and control module 68 may execute to automatically update the timer set point. Additionally, the central processing server 134 may provide a combination of a power level and a cooking time for a specific microwave oven model which may be used by the autonomy module 122 to reset a power level and a cooking time in the microwave oven 20.

In step 1006, microwave oven 20 transmits sensor data from any or all of rotational position and/or speed sensor 65, weight sensor 67, infrared thermal imaging camera 62 (or multiple cameras if present), optical camera 69, hygrometer 69, and microphone 73 to central processing server 134. Any or all of the data may be dynamic such that the sensor values are transmitted with an associated time value. Central processing server 134 may re-execute a food identification database query of the databases 136-139 and 141 or may redetermine updated cooking parameters based on the data from step 1006 and transmit the updated cooking parameter(s) to the microwave oven 20, which receives the updated parameters in step 1007. In step 1008 microwave oven 20 may adjust the setpoint of a cooking controller based on the received updated cooking parameters from step 1007. If cooking is complete, the method ends (step 1009). Otherwise, control transfers to step 1006. Thus, the method of FIG. 7 provides crowdsourced cooking parameters which may be dynamically updated during a cooking operation.

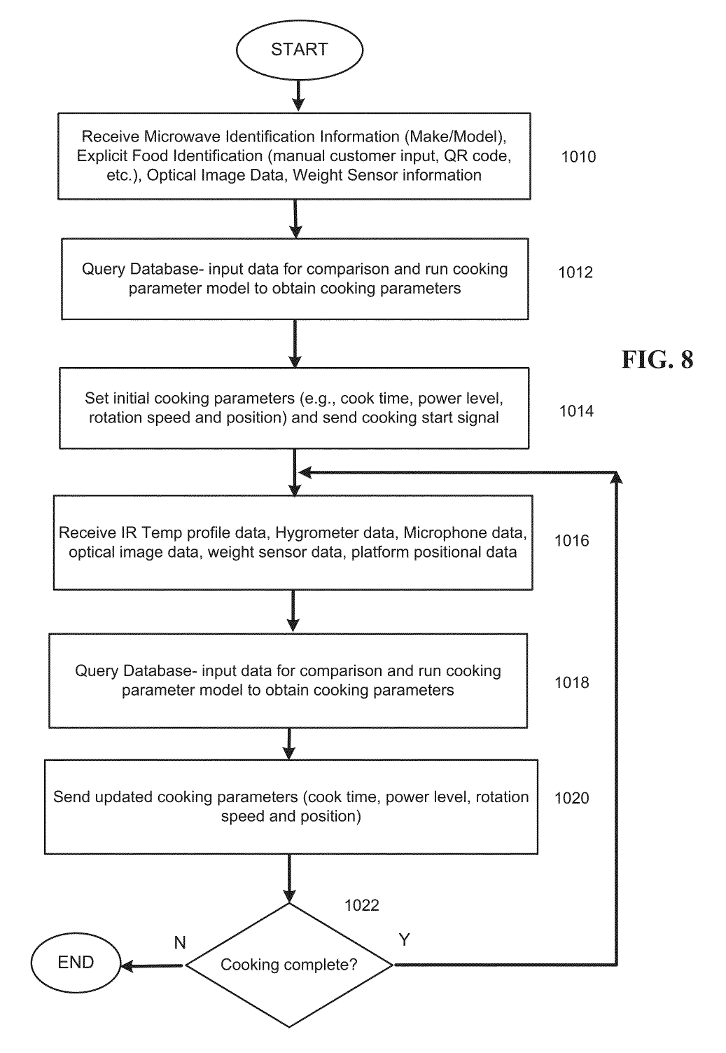

A method of generating crowdsourced cooking parameters is illustrated in FIG. 8. In accordance with the method, in step 1010 central processing server 134 receives microwave identification information (make/model), explicit food identification information (e.g., manual user input, a QR code, bar code, etc.) optical image data from camera 69 and weight data from weight sensor 67.

In step 1012 central processing server 134 executes a program that queries any or all of databases 136-139 and 141 to obtain cooking parameters based on the food item identified by the querying process and by running a cooking parameter model to obtain cooking parameters corresponding to the identified food item (and in certain cases, corresponding also to the make and model of the microwave oven 20).

In step 1014 the initial cooking parameters (e.g., cooking time, food temperature, power level, rotational speed, and/or rotational position) are transmitted to microwave oven 20 along with an instruction to begin cooking.

As cooking progresses, microwave oven 20 will collect and transmit data from infrared thermal imaging camera 62, optical camera 69, hygrometer 69, microphone 73, weight sensor 65, and rotating platter position and/or speed indicator 67 to central processing server along with time-stamps to indicate the dynamic profiles of the sensor data (step 1016). In step 1018 the databases 136-139 and 141 are queried to obtain updated cooking parameters. The cooking parameters may be updated, for example, because the database queries determine that the food item being cooked is different from the one identified in step 1012 or because the cooking parameter model applicable to a given food item has changed.

In step 1020 updated cooking parameters are transmitted to the microwave oven 20 for use in dynamically adjusting the cooking operation. If cooking is complete, the method ends (step 1020). Otherwise, control transfers to step 1016, and the dynamic updating of received sensor data and cooking parameters continues.

In some cases, a user may determine that a food item is insufficiently heated and may continue to cook it. Historical temperature profile data may be used to distinguish such reheating events from the cooking of a new food item so that the central processing server 134 may distinguish the two events. If an item is reheated, the total cooking time of the initial heating and reheating events may be aggregated to determine the total cooking time for that particular cooking event. If temperatures are tracked in the cooking parameter model, the final temperature(s) (or average) after the final reheating step may be used as the final temperature for purposes of developing the crowdsourced model.

Once the cooking event has been completed, in step 1022 (or in a separate step) a crowdsourced model is updated based on the data for the completed cooking event. The model may comprise, as one example, a set of statistical averages of various cooking parameters which is updated based on the newly received cooking parameters. For example, a cooking event may have a particular power level that was used for a particular cooking time or a series of power levels and cooking times. These may be used to develop a model of user determined cooking times and power levels deemed suitable to satisfactorily cook a particular food item. Alternatively, a cooking event may have a final average temperature that was reached for a food item, and that final average temperature may be used to develop a model of user determined cooking temperatures for a particular food item.

The foregoing descriptions of specific embodiments have been presented for purposes of illustration and description. They are not intended to be exhaustive or to limit the invention to the precise forms disclosed. Many modifications and variations are possible in light of the above teachings, with modifications and variations suited to the particular use contemplated.

What is claimed is:

1. A microwave oven, comprising:
a housing comprising an internal heating chamber;
a microwave radiation generator;
at least one infrared thermal imaging camera having a field of view in the heating chamber, wherein the at least one infrared thermal imaging camera generates a set of temperature signals, each temperature signal in the set of temperature signals having a value and corresponding to a location within the field of view;
a controller, wherein the controller is programmed to receive the set of temperature signals and adjust a cooking parameter based on the values of the temperature signals in the received set of temperature signals.

2. The microwave oven of claim 1, further comprising a display that receives the set of temperature signals and which is selectively operable to display colors corresponding to the value of each temperature signal in the received set of temperature signals at a location on the display corresponding to the field of view location to which the signal corresponds.

3. The microwave oven of claim 1, further comprising a humidity sensor that generates a humidity sensor signal, wherein the display receives the humidity sensor signal and is selectively operable to display a value corresponding to the humidity sensor signal.

4. The microwave oven of claim 1, wherein the controller is programmed to end a cooking operation when the temperature signal values at a threshold number of field of view locations reach or exceed a set-point.

5. The microwave oven of claim 1, wherein the controller is programmed to calculate an average of the temperature signal values for the plurality of temperature signals and end a cooking operation when the average reaches or exceeds a set-point.

6. The microwave oven of claim 1, wherein the controller is programmed to receive at least one cooking parameter from a central processing server and adjust a setpoint of the controller based on the received at least one cooking parameter.

7. The microwave oven of claim 1, wherein the controller is programmed to determine whether a current temperature signal is indicative of the presence of food at the field of view location corresponding to the current temperature signal.

8. The microwave oven of claim 1, wherein the microwave oven includes a rotating platter in the internal heating chamber, and the controller is programmed to dynamically determine which temperature values in the set of temperature values correspond to locations on a rotating food item, store the temperature values in association with data indicative of the locations on the rotating food item, and adjust a cooking parameter based on the stored temperature values associated with locations on the food item.

9. A microwave oven system, comprising:
a remote computing device;
the microwave oven of claim 1, further comprising:
a wireless transceiver, wherein the wireless transceiver receives the set of temperature signals from the at least one infrared thermal imaging camera and transmits a set of wireless signals corresponding to the set of temperature signals to the remote computing device, the remote computing device comprises a display, a CPU and at least one non-transitory computer readable medium having computer executable instructions programmed thereon, wherein the display receives signals corresponding each temperature signal in the set of temperature signals and displays colors corresponding to the value of each temperature signal at locations on the display which correspond to the locations in the field of view to which the temperature signals in the set of temperature signals correspond.

10. A microwave oven, comprising:
a housing comprising an internal heating chamber;
a microwave radiation generator;
at least one infrared thermal imaging camera having a field of view in the heating chamber, wherein the at least one infrared thermal imaging camera generates a set of temperature signals, each temperature signal in the set of temperature signals having a value and corresponding to a location within the field of view;
a display that is operable to selectively display a heat map, wherein the heat map comprises colors corresponding to the value of the temperature signals in the set of temperature signals at locations on the display corresponding to the field of view locations to which the temperature signals correspond.

11. The microwave oven of claim 10, further comprising an optical camera located in the internal heating chamber, wherein the display receives image signals from the optical camera and is operable to selectively display images corresponding to the received image signals.

12. The microwave oven of claim 10, further comprising a computing module comprising a central processing unit and a non-transitory computer readable medium having computer executable instructions stored thereon, wherein the computing module receives image signals from the optical camera and the set of temperature signals, when executed by the central processing unit, the computer executable instructions generate a composite image based on the optical camera image signals and the heat map, and the display is selectively operable to display the composite image.

13. The microwave oven of claim 10, wherein the at least one infrared thermal imaging camera comprises three infrared thermal imaging cameras, and the microwave oven further comprises a computing module comprising a central processing unit and a non-transitory computer readable medium having computer executable instructions stored thereon, wherein the computing module receives a set of temperature signals from each infrared thermal imaging camera, when executed by the central processing unit, the computing module generates composite images based on the temperature signals from the three infrared thermal imaging cameras, and the display is selectively operable to display the composite images.

14. A microwave oven system, comprising:
a remote computing device having a display; and
a microwave oven, wherein the microwave oven comprises:
a housing having an internal heating chamber;
a microwave radiation generator;
at least one infrared thermal imaging camera having a field of view in the internal heating chamber, wherein the at least one infrared thermal imaging camera generates a set of temperature signals, each temperature signal having a value and corresponding to a location in the field of view;
a wireless transceiver, wherein the wireless transceiver receives the set of temperature signals from the at least one infrared thermal imaging camera and transmits wireless signals corresponding to the set of temperature signals to the remote computing device, the remote computing device comprises a display, a central processing unit and at least one non-transitory computer readable medium having computer executable instructions stored thereon, wherein the display is selectively operable to display colors corresponding to the value of the temperature signals in the set of temperature signals at locations on the display which correspond to the locations in the field of view to which the temperature signals in the set of temperature signals correspond.

15. The microwave oven system of claim 14, wherein the remote computing device is selectively operable to display a microwave oven control interface, and when executed by the CPU, the computer executable instructions transmit a user entered cooking parameter entered in the microwave oven control interface to the wireless transceiver.

16. The microwave oven system of claim 14, wherein the microwave oven further comprises an optical camera in the internal heating chamber, the optical camera generates a set of optical image signals, the wireless transceiver receives the set of optical image signals and transmits wireless signals corresponding to the set of optical image signals to the remote computing device, and the remote computing device display is selectively operable to display images based on the received image signals.

17. A method of using crowdsourced cooking parameters to cook a food item, comprising:
providing a microwave oven comprising a cooking controller;
providing a food item;
transmitting food item identification data for the food item to a central processing server;
receiving at least one cooking parameter from the central processing server, wherein the at least one cooking parameter corresponds to the food item; and
adjusting a setpoint of the cooking controller based on the received at least one cooking parameter.

18. The method of claim 17, wherein the food item identification data comprises a set of temperature values, and each temperature value corresponds to a location on the food item in the internal heating chamber and an elapsed cooking time.

19. The method of claim 18, wherein the central processing server comprises a dynamic temperature database comprising a plurality of temperature profiles with respect to time and a plurality of food items, each food item corresponds to a temperature profile, and the central processing server is programmed to identify a food item in the dynamic temperature database from received temperature signals.

20. The method of claim 17, wherein the food item identification data comprises optical image data.

21. The method of claim 20, wherein the central processing server comprises an optical image database and a plurality of food items, each food item corresponds to a set of optical image data, and the server is programmed to identify a food item in the optical image database corresponding to received optical image data.

22. The method of claim 17, wherein the microwave oven comprises at least one thermal infrared imaging camera having a field of view in the internal heating chamber, wherein the at least one thermal infrared imaging camera generates a set of temperature signals, each having a value and corresponding to a location in the field of view, and the cooking controller is programmed to terminate a cooking event based on the set of temperature signals and the setpoint.

23. A method of generating crowdsourced cooking parameters;
providing a server connected to a network, wherein the network is connected to a plurality of microwave ovens;
receiving a plurality of cooking event data sets from the plurality of microwave ovens, wherein each cooking event data set comprises food identification data and at least one of cooking time data and food temperature data;
determining a target cooking event data set comprising at least one cooking parameter based on the received plurality of cooking event data sets.

24. The method of claim 23, wherein each cooking event data set further comprises a cooking power level.

25. The method of 23, wherein each cooking event data set further comprises a microwave oven identifier.

26. The method of claim 23, wherein each cooking event data set comprises optical image data.

27. The method of claim 26, further comprising identifying a food item in an optical image database by querying the optical image database with the optical image data in the cooking even data set.

28. The method of claim 23, wherein each cooking event data set comprises a plurality of sets of infrared thermal imaging camera temperature values and a plurality of elapsed cooking time values, wherein each elapsed cooking time value in the plurality of elapsed cooking time values corresponds to one of the sets of infrared thermal infrared imaging camera temperature values in the plurality of sets of infrared thermal imaging camera temperature values.

29. The method of claim 23, wherein the target cooking event data set further comprises a microwave oven identifier.

30. The method of claim 23, wherein the target cooking event data further comprises a food item identifier.

31. A microwave oven, comprising:
a housing comprising an internal heating chamber;
a microwave radiation generator;
a rotating platter;
at least one sensor selected from the group consisting of an optical camera, a weight sensor, a rotating platter position sensor, a rotating platter speed sensor, a humidity sensor, an infrared thermal imaging camera, and a microphone;
a controller, wherein the controller is programmed to receive a sensor signal having a sensor signal value from the at least one sensor and adjust a cooking parameter based on the sensor signal value.

32. The microwave oven of claim 31, wherein the cooking parameter comprises at least one selected from a cooking time, a rotating platter position, a rotating platter speed, and a cooking power level.

33. The microwave oven of claim 31, wherein the at least one sensor includes a microphone.
